(19) United States
(12) Patent Application Publication
(10) Pub. No.: US 2004/0021344 A1
(43) Pub. Date: Feb. 5, 2004

(54) Roof assembly for a vehicle

(76) Inventor: Dominik Beierl, Korntal-Muenchingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/415,978

(22) PCT Filed: Mar. 1, 2002
(86) PCT No.: PCT/EP02/02212

(30) Foreign Application Priority Data
Apr. 6, 2001 (DE) 101 17 174.9

(51) Int. Cl. B60J 7/047

(52) U.S. Cl. 296/220.01

(57) ABSTRACT

The invention proceeds from a roof system for a motor vehicle, in particular a passenger car, with rigid cover elements (23, 24), which are arranged, seen in the direction of travel (Fr), in tandem in a roof opening (19) of the motor vehicle and which close all of the roof openings (19) in a home position (R1, R2), whereby for at least partial release of a front partial opening (20) the front cover element (23) can be displaced with the rear cover element (24) in overlapping position (U1); and for at least partial release of a rear partial opening (21) of the roof opening (19) the rear cover element (24) can be moved with the front cover element (23) in overlapping position (U2).

In order not to detract from the head freedom of the occupants in the interior (30) of the motor vehicle, it is provided that the rear cover element (24) can be lowered out of its home position (R2) into a plane (E) parallel to its home position (R2) into a partial opening position (Te); and that the front cover element (23) can be moved over the rear cover element (24) into the overlapping position (U1).

### BACKGROUND OF THE INVENTION

The invention relates to a roof system for a motor vehicle, in particular for passenger cars.

### SUMMARY OF THE INVENTION

DE 196 34 853 C1 discloses a generic roof system. Two rigid cover elements of the roof system are arranged, when seen in the direction of travel, in tandem in an opening of the roof of a motor vehicle. The cover elements close the entire roof opening in a home position. The front cover element can be displaced with the rear cover element in overlapping position so that a front partial opening can be at least partially released. The front cover element can be lowered from its home position into a plane parallel to its home position so that it can be moved under the rear roof element. For the at least partial release of a rear partial opening of the roof opening, the rear cover element can be moved in overlapping position over the lowered front cover element. The drawback with this prior art roof system is that, when the front partial opening of the cover element is at least partially released, the cover element projects into the interior of the motor vehicle.

U.S. Pat. No. 4,801,147 A discloses a roof system, which has a cover element. The cover element is disposed in a roof opening and can be lifted out of its home position, in which it closes the roof opening. The cover element can be slid over the rear window of the motor vehicle. The drawback with this arrangement is that guide rails for the cover element are attached to the outside of the motor vehicle over the rear window.

Therefore, the object of the invention is to provide a roof system wherein, when the roof is open, the head freedom of the occupants at least in the front seats of the motor vehicle is not restricted or only insignificantly restricted by the cover element.

This problem is solved with a roof system that is described and claimed hereinafter.

The advantages of the invention include that, when the cover element of the roof system is lowered or tilted downward, a partial opening position or ventilation position can be provided, in which the head room of the occupants is essentially unrestricted. Even when the front partial opening is partially released, the head room of the occupants in the front seats is not reduced.

According to a further development with the features, it is advantageous that a cargo compartment, lying under the rear cover element, can be unblocked so that the cargo compartment can be loaded effortlessly.

The invention is explained in detail by means of embodiments with reference to the drawings.

### BRIEF DESCRIPTION OF THE DRAWINGS

FIG. 1 is a perspective view of a body of a motor vehicle with a roof system.

FIG. 2 depicts the roof system, according to FIG. 1, with a rear cover element in a partial opening position.

FIG. 3 depicts the roof system with a released front partial opening; and

FIG. 4 depicts the roof system with a released rear partial opening.

### DETAILED DESCRIPTION OF THE DRAWINGS

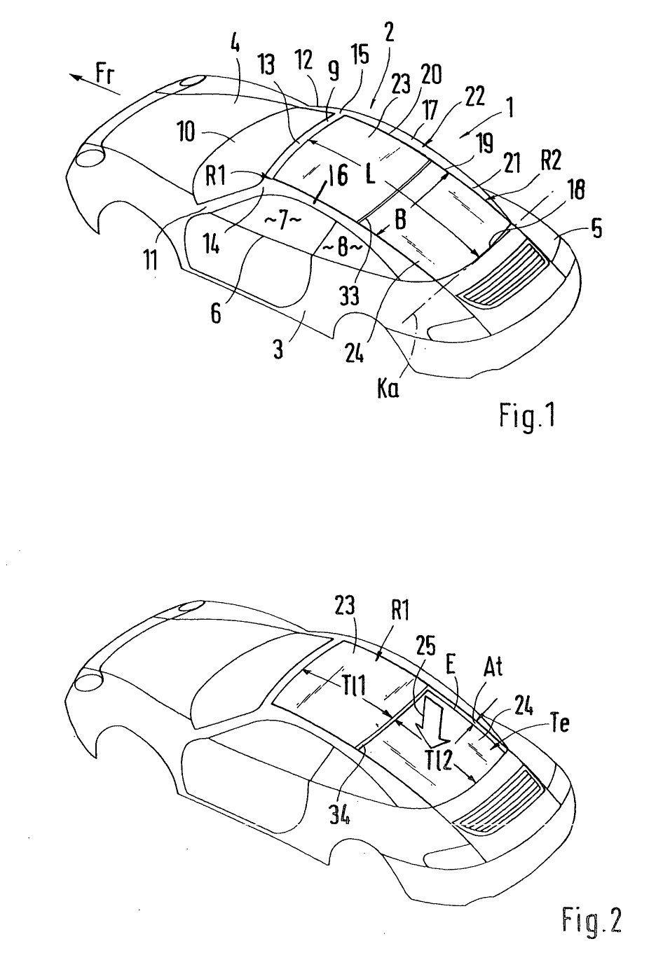

FIG. 1 depicts a body 1 of a motor vehicle, in particular a passenger car 2, which has preferably two front seats and two rear seats and of which the underbody with the wheels is not shown. The body 1 has a base body 3 with a front end 4 and a rear end 5. Side windows 7 and 8 and a windshield 10, disposed in a windshield frame 9, are provided above a belt line 6 of the body 1. The windshield frame 9 comprises side frame parts 11 and 12, which extend from the base body 3, and a windshield transverse frame part 13, which connects the ends of the side frame parts 11 and 12 that face away from the base body 3, thus forming the corner regions 14 and 15 of the windshield frame 9. At the corner regions are side longitudinal roof rails 16 and 17, which run parallel and are spaced apart from each other The side longitudinal roof rails 16 and 17 extend in the shape of an arch above the belt line 6 as far as up to the front edge 18 of the rear end, whereby this front edge 18 can lie in the peripheral belt line 6.

Between the two longitudinal roof rails 16 and 17, the transverse frame part 13 and the front edge 18 of the rear end 5 a roof opening 19 is formed that comprises a front partial opening 20 and a rear partial opening 21. Thus, the roof opening 19 has a length L between the windshield transverse frame part 13 and the front edge 18. The width B of the roof opening 19 is the result of the distance between the two side longitudinal roof rails 16 and 17.

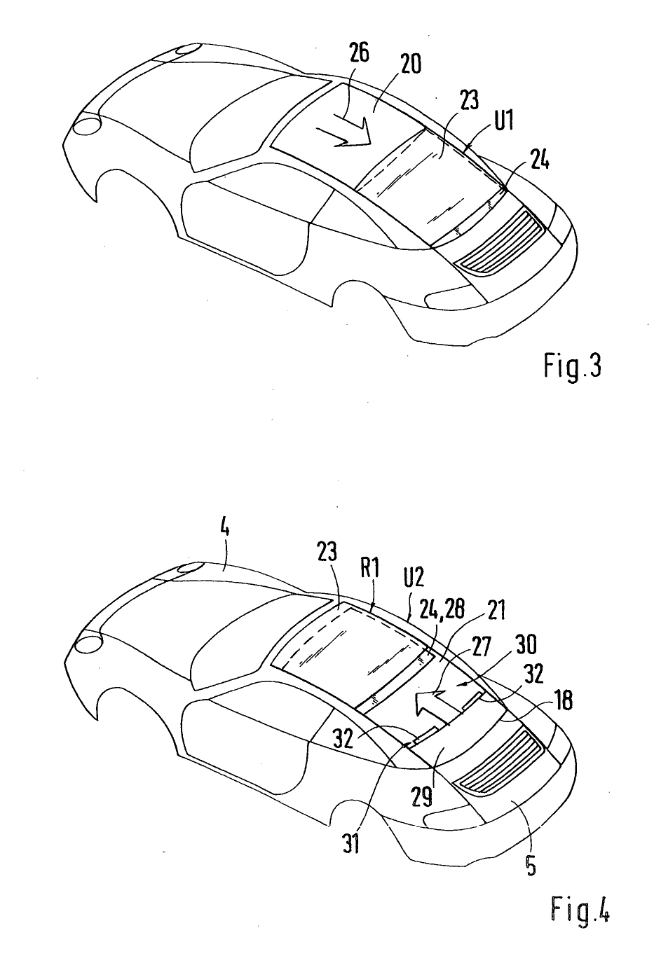

A roof system 22 is installed into the roof opening 19. The roof opening 19 is closed, seen in the direction of travel Fr, by means of several, for example two, rigid cover elements 23 and 24, which are arranged in tandem and belong to the roof system, when these cover elements 23 and 24 lie in their home position R1 or R2. The front cover element 23 is assigned to the front partial opening 20, and the rear cover element 24, to the rear partial opening 21. To release at least partially the front partial opening 20, the front cover element 23 is mounted so as to move and can be brought into overlapping position U1 (FIG. 3) with the rear cover element 24. To release at least partially the rear partial opening 21, the rear cover element 24 is mounted so as to move and can be brought into overlapping position U2 (FIG. 4) with the front cover element 23. For the motion of travel of the cover elements 23 and 24 it is provided that, according to FIG. 2, the rear cover element 24 can be lowered out of its home position R2, which is depicted in FIG. 2 and in which it closes the partial opening 21, into a plane E for the partial opening position Te, where the plane E runs approximately parallel to a plane, in which the partial opening 21 lies. Thus, the rear cover element 24 is lowered, according to the direction of the arrow 25, in parallel out of its plane in home position R2, whereby the depth of descent At is equivalent preferably to at least the thickness of the front cover element 23. The depth of descent At can also be chosen larger. Of course, it can also be smaller, when only one ventilation position of the rear cover element is supposed to be set. So that the front partial opening 20 can be released at least partially, the front cover element 23 is moved subsequently in the direction of the arrow 26 over the lowered rear cover element 24 in overlapping position U1, as depicted in FIG. 3.

Starting from the partial opening position Te of the rear cover element 24 that is depicted in FIG. 2, the rear cover element 24 can be moved to the front in the direction of the arrow 27 under the front cover element 23 in overlapping position U2, as depicted in FIG. 4. In this overlapping position U2, the rear cover element 24, which forms the rear window 28 of the motor vehicle, unblocks a cargo compartment 29, which is in the passenger interior 30 and can be arranged, for example, between the last or the rear row of seats 31, of which only the backrests 32 are depicted, and the front edge 18 of the rear end. In the overlapping position U2 of the rear cover element 24 that is depicted in FIG. 4, the front cover element is preferably in home position R1. When the rear cover element is at the home position R2 (FIG. 1), the cargo compartment 29 is covered or closed.

In a preferred embodiment, both cover elements 23 and 24 are made of a transparent and especially rigid material, preferably glass. In an advantageous design the cover elements have a sub-length T11 or T12 that is essentially identical (FIG. 2). Hence, when the sub-lengths T11 and T12 of both cover elements 23 and 24 are put in a row, the result is the length L of the roof opening 19. Thus, it is also clear that a seal 33 can lie between the two cover elements 23 and 24 when the roof opening 20 is closed (FIG. 1). Of course, it is also conceivable that between the two cover elements 23 and 24 there is a stationary roof part (not illustrated), which has preferably a very short length, compared to the sub-lengths T11 and/or T12.

The roof system 22 can have a ventilation slit 34 to ventilate the motor vehicle. The height of the slit is a function of the depth of descent At in partial opening position Te of the rear cover element 24. Starting from this partial ventilation position of the rear cover element 24, the overlapping position U1 of the front cover element 23 with the rear cover element 24 can be assumed, as evident from FIG. 3. In addition, starting from its partial opening position Te, the rear cover element 24 can be moved into its overlapping position U2, which is shown in FIG. 4, and in particular under the front cover element 23. Starting from this partial opening position Te, there are a number of possibilities for varying the different opening positions of the roof system 22. In this respect the head freedom of the occupants of the interior 30 of the motor vehicle remains unchanged especially when the partial opening 20 is open, as compared to the closed or home position R1. For the partial opening position Te, in particular the partial ventilation position, of the rear cover element 24, the rear cover element can also be tilted downward, instead of lowered, about a tilt axis Ka, which runs approximately parallel to the front edge 18. Even in the partial opening position Te, the head freedom of the occupants is unrestricted. Of course, the cover elements 23 and 24 can also be displaced into overlapping positions U1 and U2, where they overlap only partially so that the corresponding partial opening 20 or 21 is released only partially.

1. Roof system for a motor vehicle, in particular a passenger car, with rigid cover elements (23, 24), which are arranged, seen in the direction of travel (Fr), in tandem in a roof opening (19) of the motor vehicle and which close all of the roof openings (19) in a home position (R1, R2), whereby for at least partial release of a front partial opening (20) the front cover element (23) can be displaced with the rear cover element (24) in overlapping position (U1); and for at least partial release of a rear partial opening (21) of the roof opening (19) the rear cover element (24) can be moved with the front cover element (23) in overlapping position (U2), characterized in that the rear cover element (24) can be lowered out of its home position (R2) into a plane (E) parallel to its home position (R2) into a partial opening position (Te); and that the front cover element (23) can be moved over the rear cover element (24) into the overlapping position (U1).

2. Roof system, as claimed in claim 1, characterized in that the rear cover element (24) can be moved out of its lowered partial opening position (Te) to the front under the front cover element (23) into the overlapping position (U2).

3. Roof system, as claimed in any one of the preceding claims, characterized in that the cover elements (23, 24) are made of a transparent material, in particular glass.

4. Roof system, as claimed in any one of the preceding claims, characterized in that the rear cover element (24) forms the rear window (28) of the motor vehicle.

5. Roof system, as claimed in any one of the preceding claims, characterized in that in its home position (R2) the rear cover element (24) covers a cargo compartment (29), which is located, seen in the direction of travel (Fr), behind a last row of seats (31); and in overlapping position (U2) with the front cover element (23) unblocks the cargo compartment (29).

6. Roof system, as claimed in claim 1, characterized in that the roof opening (19) extends over a width (B), to be measured between two longitudinal roof rails (16, 17) of the motor vehicle.

7. Roof system, as claimed in claim 1, characterized in that the roof opening (19) extends over a length (L), to be measured between a transverse part (13) of a windshield frame and a front edge (18) of a rear end (5) of the motor vehicle.

8. Roof system, as claimed in claim 1, characterized in that the two cover elements (23, 24) exhibit, seen in the direction of travel (Fr), in essence an identical sub-length (T11, T12).
